(19) United States
(12) Patent Application Publication
(10) Pub. No.: US 2021/0004899 A1
(43) Pub. Date: Jan. 7, 2021

(54) Methods and Systems for Processing Commercial Loan Requests based on Certain Sources of Repayment

(71) Applicant: Andy Zuttah, Perth Amboy, NJ (US)

(72) Inventor: Andy Zuttah, Perth Amboy, NJ (US)

(21) Appl. No.: 16/910,428

(22) Filed: Jun. 24, 2020

Related U.S. Application Data
(60) Provisional application No. 62/869,495, filed on Jul. 1, 2019.

(51) Int. Cl. G06Q 40/02; G06Q 10/10

(52) U.S. Cl. CPC G06Q 40/025; G06Q 10/10

(57) ABSTRACT

A method and system for processing loan requests based on commercial loan sources of repayment, the method having the steps of, receiving, using a communication device, a request for a loan from a user; receiving, using a communication device, a plurality of forms from the user wherein data is extracted; receiving, using the communication device, financial data related to the loan request; and wherein such financial data is extracted from the plurality of forms and from a plurality of modules; analyzing, using a processing device, the received financial data; generating, using the processing device, an electronic report based on the analyzed financial data; and displaying, using a display device, an electronic report.

### CROSS REFERENCE TO RELATED APPLICATION

This application is a U.S. Non-Provisional Patent Application that claims priority to U.S. Provisional Patent Application No. 62/869,495 filed on Jul. 1, 2019, the contents of which are hereby incorporated by reference in their entirety.

### FIELD OF THE INVENTION

The present invention relates generally to the field of data processing. More specifically, the present disclosure facilitates methods and systems for processing loan requests based on commercial loan sources of repayment.

### BACKGROUND OF THE INVENTION

Generally, individuals or companies request financial institutions, such as banks, to provide commercial loans. However, the process of providing a loan by the financial institutions is very time consuming and error-prone. Officials at the financial institutions have to analyze data received from multiple sources to determine if an individual or a company is eligible for a loan.

Further, the process involves a lot of manual assessment by the officials at the financial institutions. The manual process may lead to errors. For example, the officials may miss data from one or more sources. Further, they make wrong assessments based on the received data.

This can lead to huge losses at the financial institutions if loans are awarded based on an erroneous assessment by the officials.

Examples of related art are described below:

U.S. Pat. No. 7,630,932 teaches methods, apparatuses and systems for facilitating analysis of expected interest rates and, in some embodiments, other conditions and circumstances associated with a variety of different loan types. In one embodiment, the present invention allows for a network-based application allowing users the ability to assess for what loan interest rates they are eligible based on current interest rate data and credit analysis scores that are used to determine qualifications for one of a variety of interest rates. In one embodiment, the present invention enables a web-based loan rate analysis system that combines credit score analysis with analyses of collateral and debt/income to offer users the ability to learn for what loan interest rates they are eligible when purchasing or refinancing a home. Embodiments of the present invention further provide “what if” calculators allowing users to assess the impact of hypothetical changes to various factors determinative of available loan rates and other circumstances associated with loans.

U.S. Pat. No. 8,160,955 teaches methods, apparatus, and articles of manufacture for capturing commercial loan application data and assigning a commercial loan request. Embodiments of the invention provide mechanisms for capturing commercial loan application data, assigning a commercial loan request, monitoring an approval process, and administering association of accounts with approved requests via a series of user interface displays communicated to a user via a network communication link. In addition, the network environment of the invention provides for the storage of data in a relational database management system that enables previously entered data to populate data fields of applets within the user interface displays without the necessity to re-enter the data. Moreover, the status of the review process may be monitored to more quickly respond to requests for such information by the customer.

U.S. Patent Publication No. 2010/0088220 teaches a data processing system that provides loan analysis for a consumer eligible to receive loan services from a particular financial institution. The data processing system performs the loan analysis by determining every existing loan of the consumer reflected in a credit report from the credit report. Each of the determined existing loans having a loan type that is offered by the particular financial institution is matched with a respective replacement loan available at the particular financial institution. The data processing system then reports a comparison of one or more determined existing loans with one or more matched replacement loans.

U.S. Patent Publication No. 2014/0143126 teaches a computer implemented method and a system for analyzing and managing multiple syndicated loan transaction elements, for example, legal loan transaction documents, bank books, compliance reports, etc, are provided. An information analysis platform (IAP) receives the syndicated loan transaction elements from multiple data sources. The IAP extracts data items from the syndicated loan transaction elements and converts the data items into multiple data fields for enhanced review, interpretation, comparison, and statistical analysis of the syndicated loan transaction elements. The IAP analyzes the syndicated loan transaction elements using the data fields via analytical tools and expert inputs received via a graphical user interface, and estimates one or more factors, for example, impact of structural elements on loss given default, probability of default and pricing, impact of each data field for short and long term changes in default and loss given default assumptions, etc., based on the analysis.

None of the art described above teaches a specific method which prints out an entire report, after the analysis of user provided information, that includes sections such as a cash flow analysis section and a risk rating section. Furthermore, none of the art teaches the need for an improved method and system for processing loan requests based on commercial loan sources of repayment that may overcome one or more of the above-mentioned problems and/or limitations.

### SUMMARY OF THE EMBODIMENTS

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A method and system for processing loan requests based on commercial loan sources of repayment, the method comprising the steps of, receiving, using a communication device, a request for a loan from a user; receiving, using a communication device, a plurality of forms from the user wherein data is extracted; receiving, using the communication device, financial data related to the loan request; and wherein such financial data is extracted from the plurality of forms and from a plurality of modules; analyzing, using a processing device, the received financial data; generating, using the processing device, an electronic report based on the analyzed financial data; and displaying, using a display device, an electronic report.

According to some embodiments, a method for processing loan requests based on commercial loan sources of repayment is disclosed. The method includes receiving, using a communication device, a request for a loan. Further, the method includes receiving, using the communication device, financial data related to the request. Yet further, the method includes analyzing, using the processing device, the received financial data. Further, the method includes generating, using the processing device, an electronic report based on the analyzing. Further, the method includes displaying, using a display device, the electronic report.

According to some aspects, a software application for processing loan requests based on commercial loan sources of repayment is disclosed. The software application may be named American Commercial Credit Underwriter (“ACCU”). The ACCU includes a user interface or front-end that is used to navigate, edit or add information into relationship analyses. The data input into relationship analyses is housed in the relational database or back-end of the ACCU application. Electronic data is manipulated using the software's user interface to have that data stored in the software's relational database. Within a relationship analysis, the ACCU sets up an identity for each borrower, guarantor and possibly ownership interests of borrowers and guarantors for a commercial loan or related commercial loans. The reliability of those monies to repay or to be able to repay related commercial loans is determined as reliable or not, by the user of the ACCU who chooses what monies to include in analyzing entities as sources of repayment. In order to assess the sources of repayment, the ACCU utilizes separate forms of analysis for different facets of commercial loan repayment; which are incorporated into a relationship analysis to create a complete electronic report based on a user's selections. According to further embodiments, the ACCU may conduct portfolio analyses that compares different commercial loans/relationship analyses by common data types and varying repayment sources. Individual loans can also be compared to the portfolio's performance and trend analyses can be performed for the entire portfolio.

It is an object of the present invention wherein the financial data is configured into a risk rating score.

It is an object of the present invention wherein the form extracted data is configured into the risk rating score.

It is an object of the present invention wherein the risk rating score is further configured on a loan description, a relationship description and on at least one source of repayment.

It is an object of the present invention wherein the at least one source of repayment includes primary, secondary and tertiary repayments.

It is an object of the present invention wherein an electronic report that includes a cash flow analysis can be generated.

It is an object of the present invention wherein a graphical user interface is comprised.

It is an object of the present invention wherein financial data and form extracted data are stored in a relational database relating to the relationship description of the user. It is an object of the present invention wherein the plurality of forms includes at least one of: Term Sheet; Relationship Account Summary; Background; Collateral Description; Real Estate Occupancy Analysis; Sole Proprietorship Cash Flow Analysis; Rental Real Estate Cash Flow Analysis; Partnership Cash Flow Analysis; S Corporation Cash Flow Analysis; Corporation Cash Flow Analysis; Organization Exempt from Income Tax Cash Flow Analysis; Balance Sheet Analysis; Financial Ratio Analysis; Receivables Analysis; Payables Analysis; Collateral Summary; Statement of Financial Condition Analysis; Personal Financial Statement Analysis; Personal Credit Report Analysis; Business Credit Report Analysis; Personal Cash Flow Analysis; Estate/Trust Cash Flow Analysis; Global Cash Flow Analysis; and Policy Exception Checklist.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 illustrates multiple commercial loan sources of repayment, in accordance with some embodiments.

FIGS. 3A-B show a list of multiple forms related to a loan request, in accordance with some embodiments.

FIG. 4 is a flowchart of a method for processing loan requests using a software application, in accordance with some embodiments.

FIG. 5 is a block diagram of a computing device for implementing the methods disclosed herein, in accordance with some embodiments.

### DETAILED DESCRIPTION OF THE PREFERRED EMBODIMENTS

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of processing loan requests, but the embodiments of the present disclosure are not limited to use only in this context.

Overview

According to some embodiments, a method for creating an electronic report, which analyzes commercial loan sources of repayment is disclosed. Further, a software application named American Commercial Credit Underwriter (“ACCU”) may be used to execute the method. The ACCU includes a user interface or front-end that is used to navigate, edit or add information into relationship analyses. The data input into relationship analyses is housed in the relational database or back-end of the ACCU application. Electronic data is manipulated using the software's user interface to have that data stored in the software's relational database.

Commercial loan sources of repayment are defined by the ACCU as monies earned or generated by the borrowers and/or the guarantors and/or the liquidation of collateral (collateral consists of property pledged in order to attempt to repay commercial loans or some portion thereof in the event of default (default is commonly known as an event in which the borrower or guarantor fails to comply with the terms of the loan), that has a measurable probability of contributing or possibly contributing to the repayment of related commercial loans (related meaning that similar monetary sources have been identified as possible sources of repayment)). Further, borrowers are assumed to have a higher measurable probability of contributing to commercial loan repayment than do guarantors. The liquidation of collateral is assumed to have the lowest measurable probability of possibly contributing to commercial loan repayment.

Within a relationship analysis, the ACCU sets up an identity for each borrower, guarantor and possibly ownership interests of borrowers and guarantors (all three parties are referred to in this document as borrowers and guarantors) for a commercial loan or related commercial loans. Each identity is referred to as an entity and collectively as entities, which are comprised of individuals and/or estates/trusts and/or companies/organizations. Since those entities are legally responsible for the repayment of related commercial loans and assuring the repayment of related commercial loans either directly or indirectly, monies that those entities receive and/or possess can be utilized to repay those commercial loans. The reliability of those monies to repay or to be able to repay related commercial loans is determined as reliable or not, by the user of the ACCU who chooses what monies to include in analyzing entities as sources of repayment.

In order to assess the sources of repayment, the ACCU utilizes separate forms of analysis for different facets of commercial loan repayment; which are incorporated into a relationship analysis to create a complete electronic report based on a user's selections. Each individual form of analysis has an associated template to house data input by the user or parsed from an electronic document. The forms can be added to and completed within a relationship analysis in any order chosen by the user. The possible forms consist of one or more of a(n) Term Sheet, Relationship Account Summary, Background, Collateral Description, Real Estate Occupancy Analysis, Sole Proprietorship Cash Flow Analysis, Rental Real Estate Cash Flow Analysis, Partnership Cash Flow Analysis, S Corporation Cash Flow Analysis, Corporation Cash Flow Analysis, Organization Exempt from Income Tax Cash Flow Analysis, Balance Sheet Analysis, Financial Ratio Analysis, Receivables Analysis, Payables Analysis, Collateral Summary, Statement of Financial Condition Analysis, Personal Financial Statement Analysis, Personal Credit Report Analysis, Business Credit Report Analysis, Personal Cash Flow Analysis, Estate/Trust Cash Flow Analysis, Global Cash Flow Analysis, Policy Exception Checklist, Risk Rating for Commercial & Industrial Commercial Loans, Risk Rating for Commercial Real Estate & Construction Commercial Loans.

In a preferred embodiment, all aforementioned forms generate data that is processed and factored into a Risk Rating for a Commercial Loan Relationship and a corresponding Risk Rating Score. The Risk Rating Score is based on the Loan Description, Relationship Description and the Sources of Repayment (primary, secondary and tertiary).

Each relationship analysis is considered to be a “live” document (“live” document is defined to mean ready to receive and display updated data on an ongoing basis) where an electronic report is created to represent a snapshot of that relationship analysis, capable of analyzing the commercial loan repayment sources at different points in time. This means that an ACCU relationship analysis is not a “static” document (“static” document defined to mean a report created for one point in time only, which would require a new document to analyze a different point in time). As such, updates made to an ACCU relationship analysis represent updates made to a bank's entire portfolio of commercial loans in real time. Each relationship analysis, therefore, represents a page in a book (in this case that book is an entire portfolio of relationship analyses or commercial loans).

This sets the stage for the ACCU's ability to conduct portfolio analyses that compare different commercial loans/relationship analyses by common data types and varying repayment sources. Therefore, the performance of the repayment sources can be assessed for correlation to numerous variables throughout a relationship analysis at different points in time to come up with a projected loan repayment ability. The correlation of those variables to the loan repayment ability could, therefore, be used to perform predictive analyses. Individual loans can also be compared to the portfolio's performance and trend analyses can be performed for the entire portfolio.

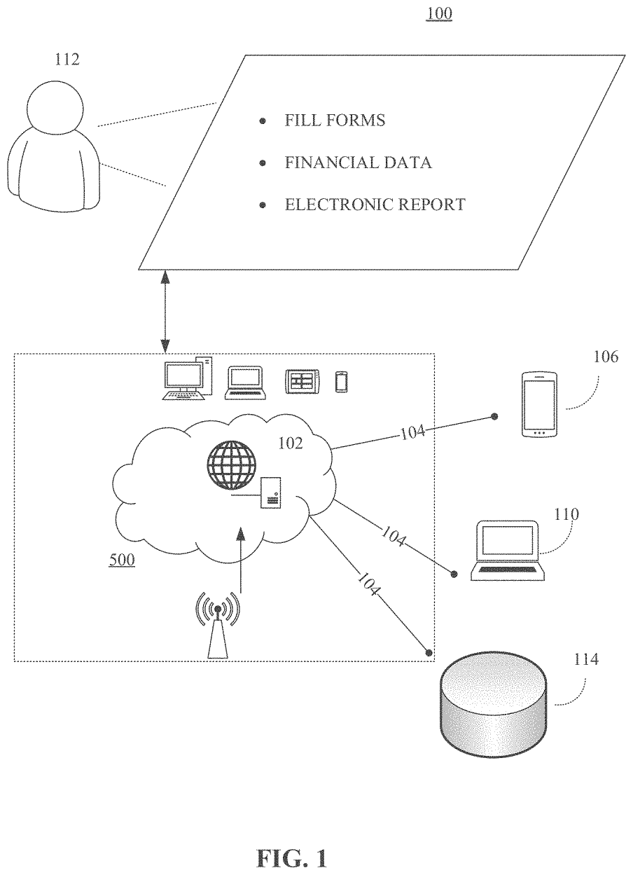

Referring now to figures, FIG. 1 is an illustration of an online platform 100 consistent with various embodiments of the present disclosure. By way of non-limiting example, the online platform 100 for processing loan requests based on commercial loan sources of repayment may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (such as bank databases, credit score databases, property registration databases, income tax filing databases), over a communication network 104, such as, but not limited to, the Internet. Further, users of the online platform 100 may include relevant parties such as, but not limited to, borrowers, bank officials, financial consultants, and administrators. Accordingly, in some instances, electronic devices operated by the one or more relevant parties may be in communication with the online platform 100.

A user 112, such as the one or more relevant parties, may access the online platform 100 through a web based software application or browser. The web based software application may be embodied as, for example, but not be limited to, a website, a web application, a desktop application, and a mobile application compatible with a computing device 500.

According to some embodiments, a method for processing loan requests based on commercial loan sources of repayment is disclosed. The method includes receiving, using a communication device, a request for a loan. For example, a prospective borrower may send the request for the commercial loan. The request may be related to a personal loan or a commercial loan. Further, the request may be related to one or more of mortgage loans, car loans, home equity lines of credit, credit cards, installment loans and payday loans.

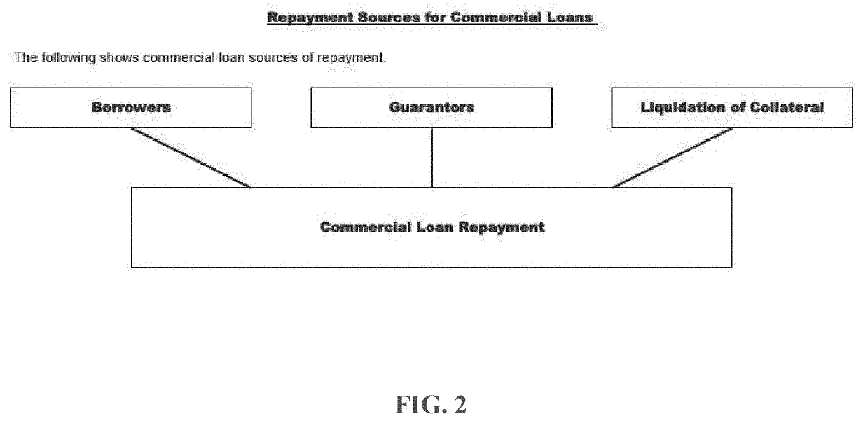

Further, the method includes receiving, using the communication device, financial data related to the request. Further, the financial data may be obtained from one or more repayment sources of commercial loans. The repayment sources of commercial loans may be defined as monies earned or generated by the borrowers and/or the guarantors and/or the liquidation of collateral that has a measurable probability of contributing or possibly contributing to the repayment of related commercial loans. The collateral consists of property pledged in order to attempt to repay commercial loans or some portion thereof in the event of default. The default is commonly known as an event in which the borrower or guarantor fails to comply with the terms of the loan. Generally, borrowers are assumed to have a higher measurable probability of contributing to commercial loan repayment than do guarantors. The liquidation of collateral is assumed to have the lowest measurable probability of possibly contributing to commercial loan repayment. FIG. 2 illustrates multiple commercial loan sources of repayment, in accordance with some embodiments.

Accordingly, the financial data may be provided by the prospective borrower. Further, the financial data may be obtained from one or more third-party sources, such as, but not limited to, bank accounts, property registration databases, credit score databases, and income tax filing databases. Some of the third-party sources may be publically accessible. However, for some of the third-party sources, authorization from the prospective borrower is required to obtain the required financial data.

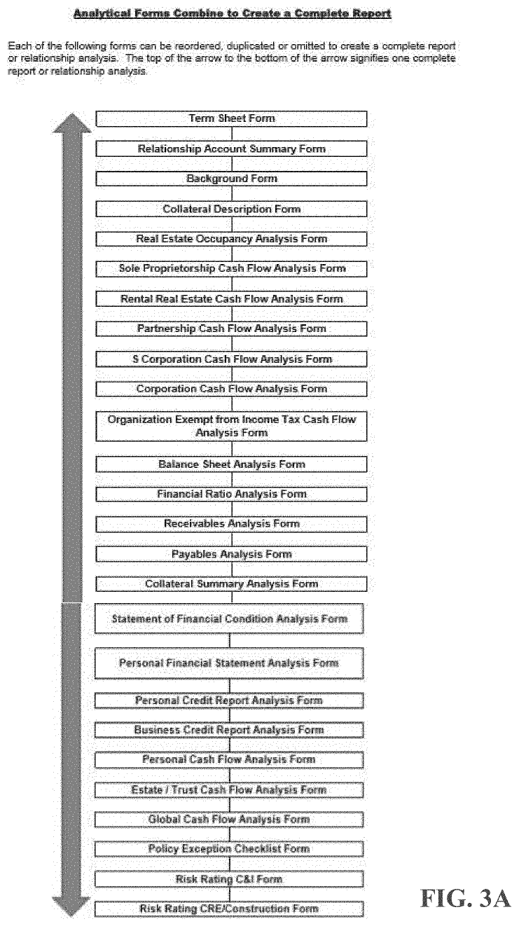

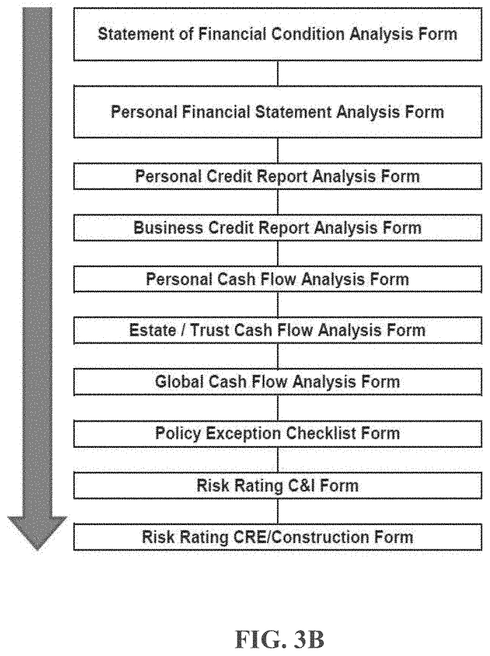

In some embodiments, the financial data may be retrieved using one or more forms. The prospective borrower may fill one or more fields in the one or more forms. Further, some of the one or more fields in the one or more forms may be filled automatically based on the data received from the third-party sources. FIGS. 3A-B show a list of multiple forms related to a loan request, in accordance with some embodiments. Further, the one or more forms are provided in the appendix section below. The one or more forms include the following:
Term Sheet—Describes the conditions under which commercial loans are made to borrowers
Relationship Account Summary—Summarizes the loan and depository relationship/history that the entities have with a particular bank; may also parse or import data from banking platform software
Background—Describes the terms and history of the commercial loans that may be repaid by the entities analyzed; also describes and identifies those entities by relevant education and/or business experience, formation dates, legal entity operating types and business operations, etc.
Collateral Description—Describes the property serving as collateral for the commercial loans involved in that relationship analysis
Real Estate Occupancy Analysis—outlines the tenants for real property and the terms of their tenancy; may also parse or import data from electronic rent rolls
Sole Proprietorship Cash Flow Analysis—details the cash flow analysis for a sole proprietorship; may also use electronic income statements and debt schedules that data can be parsed or imported from
Rental Real Estate Cash Flow Analysis—details the cash flow analysis for rental real estate; may also use electronic income statements and debt schedules that data can be parsed or imported from
Partnership Cash Flow Analysis—details the cash flow analysis for a partnership; may also use electronic income statements and debt schedules that data can be parsed or imported from
S Corporation Cash Flow Analysis—details the cash flow analysis for an S corporation; may also use electronic income statements and debt schedules that data can be parsed or imported from
Corporation Cash Flow Analysis—details the cash flow for a corporation; may also use electronic income statements and debt schedules that data can be parsed or imported from
Organization Exempt from Income Tax Cash Flow Analysis—details the cash flow for an organization exempt from income tax; may also use electronic income statements and debt schedules that data can be parsed or imported from
Balance Sheet Analysis—details the asset, liability and net worth composition for companies and organizations; may also use electronic balance sheets that data can be parsed or imported from
Financial Ratio Analysis—measures certain ratios exhibited by the income statement and balance sheet for companies and organizations
Receivables Analysis—demonstrates an outline of a company or organization's outstanding receivables by days outstanding and concentrations therein; may also use electronic receivable aging reports that data can be parsed or imported from
Payables Analysis—demonstrates an outline of a company or organization's outstanding payables by days outstanding and concentrations therein; may also use electronic payable aging reports that data can be parsed or imported from
Collateral Summary—measures the value of collateral pledged for commercial loans against amounts owed on loans secured by said collateral
Statement of Financial Condition Analysis—measures the asset, liability and net worth composition for estates and trusts; may also use electronic statements of financial condition that data can be parsed or imported from
Personal Financial Statement Analysis—measures the asset, liability and net worth composition for individuals; may also use electronic personal financial statements that data can be parsed or imported from
Personal Credit Report Analysis—outlines the credit history for individuals from personal credit reports; may also use electronic personal credit reports that data can be parsed or imported from
Business Credit Report Analysis—outlines the credit history for companies and organizations from business credit reports; may also use electronic business credit reports that data can be parsed or imported from
Personal Cash Flow Analysis—details the cash flow analysis for individuals; may also use electronic tax return info that data can be parsed or imported from
Estate/Trust Cash Flow Analysis—details the cash flow analysis for estates or trusts; may also use electronic tax return info that data can be parsed or imported from
Global Cash Flow Analysis—details the global cash flow analysis for the pertinent entities; Historical, present and estimates of future relatively reliable monies received by all entities involved is combined over predefined periods of time and measured against all monies paid by those entities for their combined expenses and their combined debts (debts including those commercial loans made by a particular bank, as well as other loans made to that entity)
Policy Exception Checklist—lists a particular bank's policy guidelines for commercial loans, in relation to the qualities of the terms and financial information for a commercial loan's compliance with those guidelines
Risk Rating for Commercial & Industrial Commercial Loans—assigns a rating or score based on a predetermined sliding scale stemming from the underlying rating or scoring for all sources of repayment for C&I commercial loans
Risk Rating for Commercial Real Estate & Construction Commercial Loans—assigns a rating or score based on a predetermined sliding scale stemming from the underlying rating or scoring for all sources of repayment for CRE & Construction commercial loans

In some embodiments, the financial data may be obtained by performing Optical Character Recognition (OCR) on one or more documents.

Yet further, the method includes analyzing, using the processing device, the received financial data. The analyzing includes determining the chances of the loan being repaid.

For example, the loan may include a repayment plan which indicates the monthly installments. The analyzing may include determining if the prospective borrower would be able to make repayments as per the repayment plan. Further, the analyzing may include determining if the guarantor would be able to make the repayments as per the repayment plan if the prospective borrower fails to make the repayments as per the repayment plan. Moreover, the analyzing may include determining if the collateral can be liquidated to recover loan amount if the prospective borrower and the guarantor fail to make the repayments.

Further, the analyzing may include assessing for correlation to numerous variables (related to the financial data) throughout a relationship analysis at different points in time to come up with a projected loan repayment ability. The correlation of those variables to the loan repayment ability may be used to perform predictive analyses.

Further, the method includes generating, using the processing device, an electronic report based on the analyzing. The electronic report may include the outcome of the analyzing. The electronic report may include the loan repayment ability. Further, FIGS. 3A-B indicate a structure of the electronic report.

Further, the method includes displaying, using a display device, the electronic report. The displaying may further include receiving the electronic report. For example, the electronic report may be obtained from the online platform 100.

According to the further embodiments, the method may include updating the electronic report. For example, the report may be updated in real-time. Alternatively, the report may be updated periodically. The report may be updated based on financial data that may change with time, such as, a new tax return, credit score, and bank account. Further, the method may include sending notifications to the borrower or officials at the respective financial institution, if the electronic report indicates a change in status with respect to loan repayment ability.

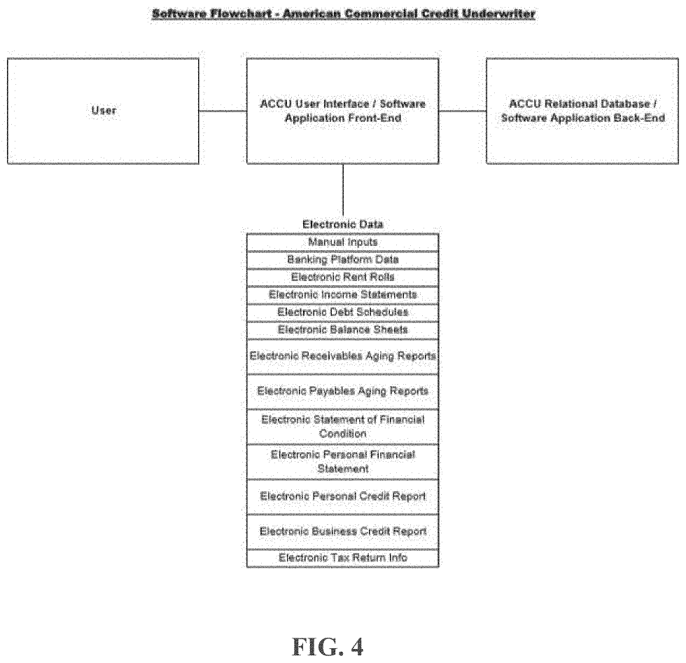

FIG. 4 is a flowchart of a method for processing loan requests using a software application, in accordance with some embodiments. The software application may be named American Commercial Credit Underwriter (“ACCU”). The ACCU includes a user interface or front-end that is used to navigate, edit or add information into relationship analyses. The data input into relationship analyses is housed in the relational database or back-end of the ACCU application. Electronic data is manipulated using the software's user interface to have that data stored in the software's relational database. Further, the user interfaces provided by the ACCU may include one or more forms in the multiple forms listed in FIGS. 3A-B.

Within a relationship analysis, the ACCU sets up an identity for each borrower, guarantor and possibly ownership interests of borrowers and guarantors for a commercial loan or related commercial loans. Each identity is referred to as an entity and collectively as entities, which are comprised of individuals and/or estates/trusts and/or companies/organizations. Since those entities are legally responsible for the repayment of related commercial loans and assuring the repayment of related commercial loans either directly or indirectly, monies that those entities receive and/or possess can be utilized to repay those commercial loans. The reliability of those monies to repay or to be able to repay related commercial loans is determined as reliable or not, by the user of the ACCU who chooses what monies to include in analyzing entities as sources of repayment.

In order to assess the sources of repayment, the ACCU utilizes separate forms of analysis for different facets of commercial loan repayment; which are incorporated into a relationship analysis to create a complete electronic report based on a user's selections. Each individual form of analysis has an associated template to house data input by the user or parsed from an electronic document. The forms can be added to and completed within a relationship analysis in any order chosen by the user.

Further, each relationship analysis is considered to be a “live” document, wherein the “live” document is defined to mean ready to receive and display updated data on an ongoing basis. The electronic report is created to represent a snapshot of that relationship analysis, capable of analyzing the commercial loan repayment sources at different points in time. This means that an ACCU relationship analysis is not a “static” document, wherein the “static” document defined to mean a report created for one point in time only, which would require a new document to analyze a different point in time. As such, updates made to an ACCU relationship analysis represents updates made to a bank's entire portfolio of commercial loans in real time. Each relationship analysis, therefore, represents a page in a book (in this case that book is an entire portfolio of relationship analyses or commercial loans).

According to further embodiments, the ACCU may conduct portfolio analyses that compares different commercial loans/relationship analyses by common data types and varying repayment sources. Therefore, the performance of the repayment sources can be assessed for correlation to numerous variables throughout a relationship analysis at different points in time to come up with a projected loan repayment ability. The correlation of those variables to the loan repayment ability could, therefore, be used to perform predictive analyses. Individual loans can also be compared to the portfolio's performance and trend analyses can be performed for the entire portfolio.

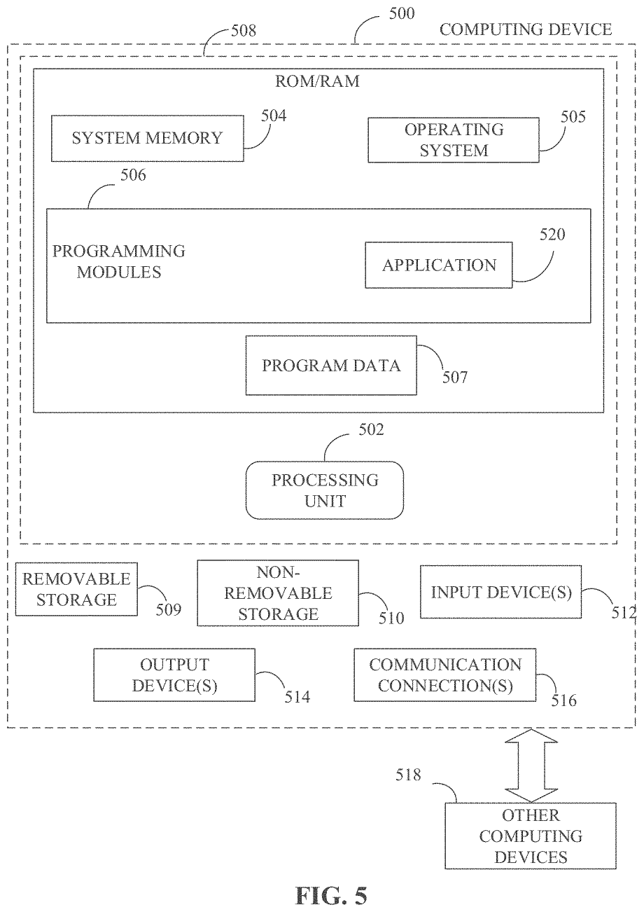

With reference to FIG. 5, a system consistent with an embodiment of the disclosure may include a computing device or cloud service, such as computing device 500. In a basic configuration, computing device 500 may include at least one processing unit 502 and a system memory 504. Depending on the configuration and type of computing device, system memory 504 may comprise, but is not limited to, volatile (e.g. random-access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include financial analysis module, machine learning module and/or artificial intelligence module. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, a location sensor, a camera, a biometric sensor, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520 such as a media player) may perform processes including, for example, one or more stages of methods, algorithms, systems, applications, servers, databases as described above. The aforementioned process is an example, and processing unit 502 may perform other processes.

In a preferred embodiment, the ACCU is configured with a plurality of modules to automatically extract data from electronic documents and other 3^{rd} party applications. The plurality of modules consists of the following:
Automated Tax Return Data Extraction Module—the system extracts data from a plurality of sources including tax returns such as IRS Forms 1065, 1120, 1120S, 8825, 1040, 1041, Schedule C and Schedule E. This module is updated annually or when necessary.
Automated Financial Statement Data Extraction Module for Company-Prepared and Accountant-Prepared Financial Statements.
Automated Non-Profit Tax Return Data Extraction Module—the system extracts data from IRS tax return Form 990.
Automated Non-Profit Financial Statement Data Extraction Module for Non-Profit Prepared and Accountant Prepared Non-Profit Financial Statements.
Automated Credit Report Data Extraction—this module can be configured to extract data from one of the hosts of other 3^{rd} party providers.
Automated Deposit and Loan Account Data Extraction Module—the system is configured to extract data from a Core Banking Platform provider through API Access.

In a preferred embodiment, the ACCU system may be utilized with various operating systems and platforms. In a preferred embodiment, the ACCU system's architecture is divided into at least three layers or tiers: presentation layer, business layer and the data layer. In the presentation layer, a user utilizes a Graphical User Interface (GUI) to perform all necessary functions of the system. When the user executes a function in the presentation layer the business layer comes into function. The business layer is the logical layer which performs all the logical representation of data. It also serves as an intermediary for data exchange between the presentation layer and the data access layer. The data access layer is configured to store all the representations of the database table types and stored procedures which are useful to perform any operation in the database.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method for processing loan requests based on commercial loan sources of repayment, the method comprising the steps of:
receiving, using a communication device, a request for a loan from a user;
receiving, using a communication device, a plurality of forms from the user wherein data is extracted;
receiving, using the communication device, financial data related to the loan request; and wherein such financial data is extracted from the plurality of forms and from a plurality of modules;
analyzing, using a processing device, the received financial data;
generating, using the processing device, an electronic report based on the analyzed financial data; and
displaying, using a display device, an electronic report.

2. The method of claim 1, wherein the financial data is configured into a risk rating score.

3. The method of claim 1, wherein the form extracted data is configured into the risk rating score.

4. The method of claim 3 wherein the risk rating score is further configured on a loan description, a relationship description and on at least one source of repayment.

5. The method of claim 4, wherein the at least one source of repayment includes primary, secondary and tertiary repayments.

6. The method of claim 1, further comprising an electronic report that includes a cash flow analysis.

7. The method of claim 1, further comprising a graphical user interface.

8. The method of claim 1, wherein financial data and form extracted data are stored in a relational database relating to the relationship description of the user.

9. The method of claim 1 wherein the plurality of forms includes at least one of: Term Sheet; Relationship Account Summary; Background; Collateral Description; Real Estate Occupancy Analysis; Sole Proprietorship Cash Flow Analysis; Rental Real Estate Cash Flow Analysis; Partnership Cash Flow Analysis; S Corporation Cash Flow Analysis; Corporation Cash Flow Analysis; Organization Exempt from Income Tax Cash Flow Analysis; Balance Sheet Analysis; Financial Ratio Analysis; Receivables Analysis; Payables Analysis; Collateral Summary; Statement of Financial Condition Analysis; Personal Financial Statement Analysis; Personal Credit Report Analysis; Business Credit Report Analysis; Personal Cash Flow Analysis; Estate/Trust Cash Flow Analysis; Global Cash Flow Analysis; and Policy Exception Checklist.

10. A system for processing loan requests based on commercial loan sources of repayment, the method comprising the steps of, the system comprising:
a communication device for receiving a request for a loan from a user;
wherein a
the communication device for receiving a plurality of forms from the user wherein data is extracted;
the communication device for receiving financial data related to the loan request; and wherein such financial data is extracted from the plurality of forms and from a plurality of modules;
a processing device for analyzing the received financial data;
the processing device for generating an electronic report based on the analyzed financial data; and
a display device, for displaying an electronic report.

11. The system in accordance with claim 10, wherein the financial data is configured into a risk rating score.

12. The system of claim 10, wherein the form extracted data is configured into the risk rating score.

13. The system of claim 12 wherein the risk rating score is further configured on a loan description, a relationship description and on at least one source of repayment.

14. The system of claim 13, wherein the at least one source of repayment includes primary, secondary and tertiary repayments.

15. The system of claim 10, further comprising an electronic report that includes a cash flow analysis.

16. The system of claim 10, further comprising a graphical user interface.

17. The system of claim 10, wherein financial data and form extracted data are stored in a relational database relating to the relationship description of the user.

18. The system of claim 10, wherein the plurality of forms includes at least one of: Term Sheet; Relationship Account Summary; Background; Collateral Description; Real Estate Occupancy Analysis; Sole Proprietorship Cash Flow Analysis; Rental Real Estate Cash Flow Analysis; Partnership Cash Flow Analysis; S Corporation Cash Flow Analysis; Corporation Cash Flow Analysis; Organization Exempt from Income Tax Cash Flow Analysis; Balance Sheet Analysis; Financial Ratio Analysis; Receivables Analysis; Payables Analysis; Collateral Summary; Statement of Financial Condition Analysis; Personal Financial Statement Analysis; Personal Credit Report Analysis; Business Credit Report Analysis; Personal Cash Flow Analysis; Estate/Trust Cash Flow Analysis; Global Cash Flow Analysis; and Policy Exception Checklist.
